(19) United States
(12) Patent Application Publication
(10) Pub. No.: US 2025/0098010 A1
(43) Pub. Date: Mar. 20, 2025

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Yang LIU, Dongguan (CN)

(21) Appl. No.: 18/972,665

(22) Filed: Dec. 6, 2024

Related U.S. Application Data
(63) Continuation of application No. PCT/CN2022/105986, filed on Jul. 15, 2022.

(51) Int. Cl. H04W 76/19; H04W 76/27

(52) U.S. Cl. CPC H04W 76/19; H04W 76/27

(57) ABSTRACT

A wireless communication method, applied to the terminal device, includes: generating first information, where the first information includes a fast MCG recovery failure report; and transmitting the first information.

### CROSS-REFERENCE TO RELATED APPLICATION

This application is a Continuation Application of International Application No. PCT/CN2022/105986 filed on Jul. 15, 2022, which is incorporated herein by reference in its entirety.

### TECHNICAL FIELD

Embodiments of the present disclosure relate to the field of communications, and more specifically, to a wireless communication method, a terminal device, and a network device.

### BACKGROUND

In the dual connectivity (Dual Connectivity, DC) scenario, when a problem occurs in a connection between a terminal device and a master cell group (Master Cell Group, MCG) (e.g., an MCG radio link failure (Radio Link Failure, RLF) occurs), if there is no problem in a connection between the terminal device and a secondary cell group (Secondary Cell Group, SCG), the terminal device may transmit MCG failure information to a master node (Master Node, MN) via an SCG link, thereby performing fast MCG recovery. In a new radio (NR) system, higher requirements are placed on the fast MCG recovery, and how to optimize the fast MCG recovery is a problem that needs to be solved.

### SUMMARY

Embodiments of the present disclosure provide a wireless communication method, a terminal device and a network device.

In a first aspect, a wireless communication method is provided and applied to a terminal device, and the method includes:

generating first information, where the first information includes a fast MCG recovery failure report; and
transmitting the first information.

In a second aspect, a wireless communication method is provided and applied to a network device, and the method includes:

receiving first information, where the first information includes a fast MCG recovery failure report.

In a third aspect, a terminal device is provided for performing the method in the above first aspect.

In some embodiments, the terminal device includes a functional module for performing the method in the above first aspect.

In a fourth aspect, a network device is provided for performing the method in the above second aspect.

In some embodiments, the network device includes a functional module for performing the method in the above second aspect.

In a fifth aspect, a terminal device is provided, and includes a processor and a memory; the memory is configured to store a computer program, and the processor is configured to invoke and execute the computer program stored in the memory, to enable the terminal device to perform the method in the above first aspect.

In a sixth aspect, a network device is provided, and includes a processor and a memory; the memory is configured to store a computer program, and the processor is configured to invoke and execute the computer program stored in the memory, to enable the network device to perform the method in the above second aspect.

In a seventh aspect, an apparatus is provided for implementing the method in any one of the above first aspect to second aspect.

In some embodiments, the apparatus includes: a processor, configured to invoke a computer program from a memory and execute the computer program, to enable a device equipped with the apparatus to perform the method in any one of the above first aspect to second aspect.

In an eighth aspect, a non-transitory computer-readable storage medium is provided for storing a computer program, where the computer program enables a computer to perform the method in any one of the above first aspect to second aspect.

In a ninth aspect, a computer program product is provided, and includes computer program instructions, where the computer program instructions enable a computer to perform the method in any one of the above first aspect to second aspect.

In a tenth aspect, a computer program is provided, where the computer program, when being executed on a computer, enables the computer to perform the method in any one of the above first aspect to second aspect.

### BRIEF DESCRIPTION OF THE DRAWINGS

FIG. 1 is a schematic diagram of a communication system architecture applied in the embodiments of the present disclosure.

FIG. 2 is a schematic diagram of a dual connection provided by the present disclosure.

FIG. 3 is a schematic diagram of a terminal device far away from an MN and an SN provided by the present disclosure.

FIG. 4 is a schematic interactive flowchart of a wireless communication method provided according to the embodiments of the present disclosure.

FIG. 5 is a schematic block diagram of a terminal device provided according to the embodiments of the present disclosure.

FIG. 6 is a schematic block diagram of a network device provided according to the embodiments of the present disclosure.

FIG. 7 is a schematic block diagram of a communication device provided according to the embodiments of the present disclosure.

FIG. 8 is a schematic block diagram of an apparatus provided according to the embodiments of the present disclosure.

FIG. 9 is a schematic block diagram of a communication system provided according to the embodiments of the present disclosure.

### DETAILED DESCRIPTION

The technical solutions in the embodiments of the present disclosure will be described in conjunction with the drawings in the embodiments of the present disclosure, and apparently, the described embodiments are a part of the embodiments of the present disclosure, but not all of the embodiments. For the embodiments of the present disclosure, all other embodiments obtained by the ordinary skilled in the art belong to the protection scope of the present disclosure.

The technical solutions of the embodiments of the present disclosure may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of an NR system, an LTE-based access to unlicensed spectrum (LTE-U) system, an NR-based access to unlicensed spectrum (NR-U) system, a Non-Terrestrial communication Network (Non-Terrestrial Networks, NTN) system, a Universal Mobile Telecommunication System (UMTS), a Wireless Local Area Network (WLAN), an internet of things (IoT), a Wireless Fidelity (WiFi), a fifth-generation communication (5th-Generation, 5G) system, a sixth-generation communication (6th-Generation, 6G) system, or other communication systems, etc.

Generally speaking, a number of connections supported by a traditional communication system is limited and is easy to implement, however, with the development of the communication technology, the mobile communication system will not only support the traditional communication, but also support, for example, Device to Device (D2D) communication, Machine to Machine (M2M) communication, Machine Type Communication (MTC), Vehicle to Vehicle (V2V) communication, sidelink (SL) communication, or Vehicle to everything (V2X) communication, etc., and the embodiments of the present disclosure may also be applied to these communication systems.

In some embodiments, the communication system in the embodiments of the present disclosure may be applied to a carrier aggregation (CA) scenario, may also be applied to a dual connectivity (DC) scenario, and may also be applied to a standalone (SA) network deployment scenario, or applied to non-standalone (NSA) network deployment scenario.

In some embodiments, the communication system in the embodiments of the present disclosure may be applied to an unlicensed spectrum, where the unlicensed spectrum may also be considered as a shared spectrum; or the communication system in the embodiments of the present disclosure may also be applied to a licensed spectrum, where the licensed spectrum may also be considered as an unshared spectrum.

In some embodiments, the communication system in the embodiments of the present disclosure may be applied to an FR1 frequency band (corresponding to a frequency band range of 410 MHz to 7.125 GHz), or may also be applied to an FR2 frequency band (corresponding to a frequency band range of 24.25 GHz to 52.6 GHz), or may also be applied to a new frequency band, such as a high frequency band corresponding to a frequency band range of 52.6 GHz to 71 GHz or corresponding to a frequency band range of 71 GHz to 114.25 GHz.

The embodiments of the present disclosure describe various embodiments in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or a user apparatus, etc.

The terminal device may be a station (STATION, STA) in the WLAN, may be a cellular phone, a cordless phone, a Session Initiation Protocol (SIP) phone, a Wireless Local Loop (WLL) station, or a personal digital assistant (PDA) device, a handheld device with a wireless communication function, a computing device or other processing devices connected to a wireless modem, a vehicle-mounted device, a wearable device, a terminal device in a next generation communication system such as in an NR network, or a terminal device in a Public Land Mobile Network (PLMN) network evolved in the future, etc.

In the embodiments of the present disclosure, the terminal device may be deployed on land, which includes indoor or outdoor, in handheld, worn or vehicle-mounted; may also be deployed on water (e.g., on a ship, etc.); may also be deployed in the air (e.g., on an airplane, a balloon, a satellite, etc.).

In the embodiments of the present disclosure, the terminal device may be a mobile phone, a pad, a computer with a wireless transceiving function, a Virtual Reality (VR) terminal device, an Augmented Reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, a vehicle-mounted communication device, a wireless communication chip/application specific integrated circuit (ASIC)/system on chip (SoC), etc.

As an example but not a limitation, in the embodiments of the present disclosure, the terminal device may also be a wearable device. The wearable device, which is also referred to as a wearable smart device, is a generic term for a device that can be worn, into which the daily wear is intelligently designed and developed by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions through software supporting, data interaction, and cloud interaction. A generalized wearable smart device includes for example, a smartwatch or smart glasses, etc., with full functions, large size, and entire or partial functions without relying on a smartphone, as well as, for example, a smart bracelet and smart jewelry for physical sign monitoring, which only focuses on a certain type of application function and needs to be used in conjunction with other devices such as a smartphone.

In the embodiments of the disclosure, the network device may be a device used for communicating with a mobile device. The network device may be an Access Point (AP) in the WLAN, a base station (Base Transceiver Station, BTS) in the GSM or CDMA, may also be a base station (NodeB, NB) in the WCDMA, or may also be an evolutionary base station (Evolutionary Node B, eNB or eNodeB) in the LTE, or a relay station or an access point, or a vehicle-mounted device, a wearable device, and a network device or a base station (gNB) or a transmission reception point (TRP) in an NR network, or a network device in the PLMN network evolved in the future or a network device in the NTN network, etc.

As an example but not a limitation, in the embodiments of the present disclosure, the network device may have a mobile characteristic, for example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. In some embodiments, the network device may also be a base station provided on land, water, and other places.

In the embodiments of the present disclosure, the network device may provide a service for a cell, and the terminal device communicates with the network device through a transmission resource (such as a frequency domain resource, or a frequency spectrum resource) used by the cell. The cell may be a cell corresponding to the network device (such as the base station), the cell may belong to a macro base station or may also belong to a base station corresponding to a small cell, and the small cell here may include: a metro cell, a micro cell, a pico cell, a femto cell, etc., these small cells have characteristics of small coverage range and low transmission power, which are applicable for providing a data transmission service with high speed.

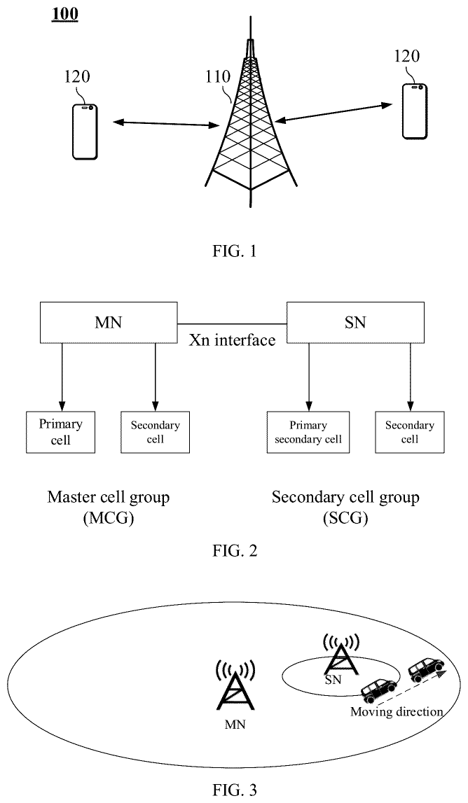

Exemplarily, the communication system 100 applied by the embodiments of the present disclosure is shown in FIG. 1. The communication system 100 may include a network device 110, and the network device 110 may be a device that communicates with a terminal device 120 (also referred to as a communication terminal or a terminal). The network device 110 may provide communication coverage for a specific geographical area and may communicate with a terminal device located within the coverage area.

FIG. 1 exemplarily shows one network device and two terminal devices, and in some embodiments, the communication system 100 may include a plurality of network devices and may include another number of terminal devices within a coverage range of each network device, the embodiments of the present disclosure are not limited thereto.

In some embodiments, the communication system 100 may also include other network entities such as a network controller and a mobility management entity, for example, a user plane function (User Plane Function, UPF), an access and mobility management function (Access and Mobility Management Function, AMF), a session management function (Session Management Function, SMF), etc., which is not limited to the embodiments of the present disclosure.

It should be understood that, in the embodiments of the present disclosure, a device with a communication function in the network/system may be referred to as a communication device. Taking the communication system 100 shown in FIG. 1 as an example, the communication device may include the network device 110 and the terminal device 120 with the communication function, and the network device 110 and the terminal device 120 may be the devices described above, which will not be repeated herein; the communication device may also include other devices in the communication system 100, such as a network controller, a mobility management entity, and other network entities, which are not limited in the embodiments of the present disclosure.

It should be understood that the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that the present document relates to a first communication device and a second communication device, and the first communication device may be a terminal device, such as a mobile phone, a machine facility, a customer premise equipment (CPE), an industrial device, a vehicle, etc; the second communication device may be a counterpart communication device of the first communication device, such as a network device, a mobile phone, an industrial device, a vehicle, etc. In the embodiments of the present disclosure, the first communication device may be a terminal device, and the second communication device may be a network device (i.e., an uplink communication or a downlink communication); or, the first communication device may be a first terminal, and the second communication device may be a second terminal (i.e., a sidelink communication).

The terms used in the implementation parts of the present disclosure are only used to explain embodiments of the present disclosure and are not intended to limit the present disclosure. The terms “first”, “second”, “third” and “fourth” etc., in the description, claims and drawings of the present disclosure are used to distinguish different objects rather than to describe a specific order. In addition, the terms “including” and “having” and any derivations thereof are intended to cover non-exclusive inclusion.

It should be understood that the “indication” and variants thereof mentioned in the embodiments of the present disclosure may be a direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B.

In the description of the embodiments of the present disclosure, the term “correspondence” and variants thereof may mean that there is a direct correspondence or indirect correspondence between the two, it may also mean that there is an associated relationship between the two, or it may also mean a relationship of indicating and being indicated or a relationship of configuring and being configured, etc.

In the embodiments of the present disclosure, “predefined” or “preconfigured” and variants thereof may be implemented by pre-saving corresponding codes, tables or other manners that may be used to indicate related information, in the device (for example, including the terminal device and the network device), and the present disclosure does not limit its specific implementation. For example, the predefined may refer to what is defined in a protocol.

In the embodiments of the present disclosure, the “protocol” may refer to standard protocols in the communication field, for example, which may be an evolution of the existing LTE protocol, NR protocol, Wi-Fi protocol, or other communication system-related protocols related thereto. The present disclosure does not limit the protocol type.

To facilitate the understanding of technical solutions of the embodiments of the present disclosure, the technical solutions of the present disclosure are described in detail below through some embodiments. The following related technologies, as optional solutions, may be randomly combined with the technical solutions of the embodiments of the present disclosure, which all belong to the protection scope of the embodiments of the present disclosure. The embodiments of the present disclosure include at least some of the following contents.

In order to better understand the embodiments of the present disclosure, the dual connection related to the present disclosure is explained.

In some embodiments, a dual connection system may be as shown in FIG. 2, and may include a master cell group (MCG) and a secondary cell group (SCG). The dual connection system may include the following nodes: a master node (MN), a secondary node (SN), a primary cell under the master node (Primary Cell, PCell), a secondary cell under the master node (Secondary cell, SCell), a primary cell under the secondary node (Primary Secondary cell, PSCell), and a secondary cell under the secondary node (Secondary cell, SCell). The function of dual connection is to improve the throughput of the terminal that has accessed the primary cell and is in a connected state: using a cell on the SN to provide additional spectrum resources for the terminal.

In order to facilitate a better understanding of the embodiments of the present disclosure, the fast MCG recovery related to the present disclosure is explained.

When the terminal is in a dual connection system architecture, when there is a problem (MCG RLF) with the connection between the terminal and the MCG, and if there is no problem with the connection between the terminal and the SCG, the terminal will transmit MCG failure information (MCG Failure Information) (such as split signaling radio bearers 1 (Signaling Radio Bearers 1, SRB1) or split signaling radio bearers 3 (Signaling Radio Bearers 3, SRB3)) to the MN via an SCG link.

After the terminal transmits the MCG failure indication (MCG Failure Indication) completely, the terminal waits for the MN to transmit an RRC reconfiguration message (RRCReconfiguration msg) or an RRC release (RRCRelease) signaling back to the terminal (correspondingly, the split SRB1 or SRB3 used by the terminal to transmit the MCG Failure Information is used). If the terminal receives the signaling from the MN within a certain period of time (based on a duration set by T316), the terminal performs a corresponding action according to the received signaling (such as switching to a target primary cell, or returning to an idle state to perform a primary cell selection or reselection); on the contrary, if the terminal does not receive the signaling from the MN within the certain period of time (based on the duration set by T316), the terminal needs to perform a radio resource control (Radio Resource Control, RRC) connection re-establishment process. In some embodiments, the terminal finds an appropriate cell and transmits an RRC connection re-establishment request (RRC Connection Re-establishment Request).

That is, the fast MCG recovery may mean that when the MCG RLF occurs, the terminal may transmit the MCG failure information to the MN via the SCG, and the terminal may receive the signaling transmitted by the MN via the SCG, thereby implementing the fast recovery of the MCG based on the signaling transmitted by the MN.

As can be seen from the above, if T316 is set to be relatively long, and the terminal cannot receive the RRC reconfiguration message or the RRC release signaling transmitted via the SN, the terminal needs to wait until T316 expires before initiating the cell selection and re-establishment. As shown in FIG. 3, the terminal (a vehicle or a vehicle-mounted terminal in FIG. 3) moves from a place where the MN coverage is poor to a place where both the MN coverage and the SN coverage are poor, that is, the terminal moves from a location where the MN signal is poorly received to a location where both the MN signal and the SN signal are poorly received, and the terminal cannot receive, via the SCG, the RRC reconfiguration message or the RRC release signaling from the MN. Assuming that the network finds that terminals at a certain location always experience the MCG failure and then experience the SCG failure, which proves that the terminals at the location are not appropriate for being configured with an overly long T316. Alternatively, assuming that the network finds that terminals holding measurement results within a fixed range always experience the MCG failure and then experience the SCG failure, it is proved that this type of terminals is not appropriate for being configured with an overly long T316.

In some embodiments, the duration of T316 is configured by the network itself. In some cases, the duration of T316 is not set reasonably. In addition, in the NR system, higher requirements are placed on the fast MCG recovery, and how to optimize the fast MCG recovery is a problem that needs to be solved.

Based on the above problems, the present disclosure proposes an optimization solution for the fast MCG recovery, by which the terminal device reports a fast MCG recovery failure report, so that the network device may optimize the fast MCG recovery based on the fast MCG recovery failure report.

In the embodiments, a wireless communication method is provided, which is applied to a terminal device and includes:

generating first information, where the first information includes a fast master cell group (MCG) recovery failure report; and
transmitting the first information.

In some embodiments, the fast MCG recovery failure report includes at least one of:

location information of the terminal device, an identity of a failed primary cell, configured duration information of T316, a measurement result of a cell in a secondary cell group (SCG), indication information used to indicate that the terminal device has performed a fast MCG recovery, or indication information used to indicate that the terminal device has transmitted an MCG failure indication.

In some embodiments, the location information of the terminal device includes at least one of:

location information of the terminal device before an MCG failure occurs, or location information of the terminal device before the terminal device transmits a radio resource control (RRC) re-establishment request.

In some embodiments, the measurement result of the cell in the SCG includes at least one of:

a measurement result of the cell in the SCG before an MCG failure, a measurement result of the cell in the SCG before the T316 expires, a measurement result of the cell in the SCG before the terminal device performs a cell reselection, or a measurement result of the cell in the SCG before the terminal device transmits an RRC re-establishment request.

In some embodiments, the cell in the SCG includes a primary secondary cell and/or a secondary cell.

In some embodiments, the method further includes:

generating the fast MCG recovery failure report in a case where at least one of the following conditions is met:
condition that the fast MCG recovery has been performed and the T316 has expired;
a condition that the fast MCG recovery has been performed and a cell reselection has been performed;
a condition that the fast MCG recovery has been performed and an RRC re-establishment request has been transmitted;
a condition that the MCG failure indication is transmitted to a master node (MN), and the T316 has expired;
a condition that the MCG failure indication is transmitted to an MN and a cell reselection has been performed; or
a condition that the MCG failure indication is transmitted to an MN, and an RRC re-establishment request has been transmitted.

In some embodiments, the MCG failure indication is transmitted to the MN via the SCG.

In some embodiments, the method further includes:

transmitting first indication information;
where the first indication information is used to indicate that the terminal device has the fast MCG recovery failure report to be reported.

In some embodiments, the first indication information is carried by an RRC signaling, where the RRC signaling is an RRC connection setup complete message, or the RRC signaling is an RRC connection re-establishment complete message.

In some embodiments, the method further includes:

receiving first request information;
where the first request information is used to request the terminal device to report the fast MCG recovery failure report.

In some embodiments, the transmitting the first information, includes:

transmitting the first information after the terminal device successfully performs an RRC connection re-establishment; or,
transmitting the first information after the terminal device successfully connects to a reselected primary cell.

In the embodiments, a wireless communication method is provided, which is applied to a network device and includes:

receiving first information, where the first information includes a fast master cell group (MCG) recovery failure report.

In some embodiments, the fast MCG recovery failure report includes at least one of:

location information of a terminal device, an identity of a failed primary cell, configured duration information of T316, a measurement result of a cell in a secondary cell group (SCG), indication information used to indicate that a terminal device has performed a fast MCG recovery, or indication information used to indicate that a terminal device has transmitted an MCG failure indication.

In some embodiments, the location information of the terminal device includes at least one of:

location information of the terminal device before an MCG failure, or location information of the terminal device before the terminal device transmits a radio resource control (RRC) re-establishment request.

In some embodiments, the measurement result of the cell in the SCG includes at least one of:

a measurement result of the cell in the SCG before an MCG failure, a measurement result of the cell in the SCG before the T316 expires, a measurement result of the cell in the SCG before the terminal device performs a cell reselection, or a measurement result of the cell in the SCG before the terminal device transmits an RRC re-establishment request.

In some embodiments, the cell in the SCG includes a primary secondary cell and/or a secondary cell.

In some embodiments, the fast MCG recovery failure report is generated in a case where at least one of the following conditions is met:

a condition that the fast MCG recovery has been performed and the T316 has expired;
a condition that the fast MCG recovery has been performed and a cell reselection has been performed;
a condition that the fast MCG recovery has been performed and an RRC re-establishment request has been transmitted;
a condition that the MCG failure indication is transmitted to a master node (MN), and the T316 has expired;
a condition that the MCG failure indication is transmitted to an MN and a cell reselection has been performed; or
a condition that the MCG failure indication is transmitted to an MN, and an RRC re-establishment request has been transmitted.

In some embodiments, the MCG failure indication is transmitted to the MN via the SCG.

In some embodiments, the method further includes:

receiving first indication information;
where the first indication information is used to indicate that a terminal device has the fast MCG recovery failure report to be reported.

In some embodiments, the first indication information is carried by an RRC signaling, where the RRC signaling is an RRC connection setup complete message, or the RRC signaling is an RRC connection re-establishment complete message.

In some embodiments, the method further includes:

transmitting first request information;
where the first request information is used to request a terminal device to report the fast MCG recovery failure report.

In some embodiments, the first information is transmitted after a terminal device successfully performs an RRC connection re-establishment; or,

the first information is transmitted after a terminal device successfully connects to a reselected primary cell.

In some embodiments, the method further includes:

transmitting the fast MCG recovery failure report to an MN in which a failed primary cell is located;
where the fast MCG recovery failure report is used to optimize a T316 configuration by the MN in which the failed primary cell is located.

The technical solutions of the present disclosure are described in detail below through some embodiments.

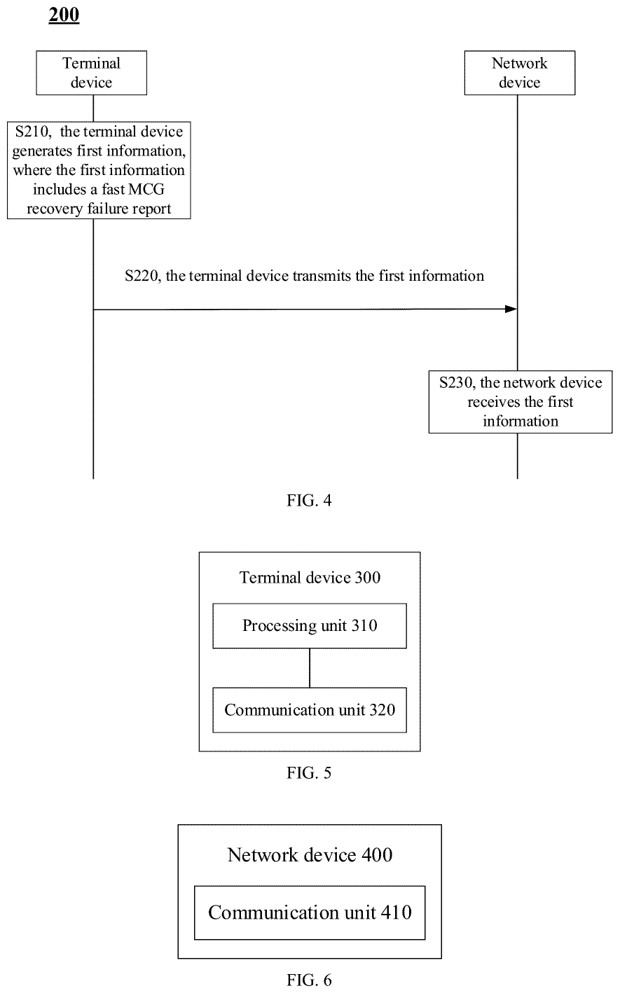

FIG. 4 is a schematic flowchart of a wireless communication method 200 according to the embodiments of the present disclosure. As shown in FIG. 4, the wireless communication method 200 may include at least a part of the following contents.

S210, a terminal device generates first information, where the first information includes a fast MCG recovery failure report.

S220, the terminal device transmits the first information.

S230, a network device receives the first information.

In the embodiments of the present disclosure, the network device (such as an MN in which a primary cell corresponding to the fast MCG recovery failure is located) may optimize the fast MCG recovery based on the fast MCG recovery failure report, for example, optimize a relevant configuration of T316 (such as the duration or starting and stopping conditions of T316). Therefore, in a case where a link quality between the terminal device and the SN deteriorates, the RRC re-establishment process may be performed faster, thereby improving the mobility and robustness of the fast MCG recovery, and meanwhile optimizing the communication system.

In some embodiments, the network device transmits the fast MCG recovery failure report to the MN in which the failed primary cell (failed PCell) is located; where the fast MCG recovery failure report is used to optimize the T316 configuration (such as the duration or starting and stopping conditions of T316) by the MN in which the failed primary cell is located.

In some embodiments, the first information may be carried by one of: an RRC signaling, uplink control information (Uplink Control Information, UCI), or a media access control control element (Media Access Control Control Element, MAC CE).

In some embodiments, after successfully performing the RRC connection re-establishment, the terminal device transmits the first information. In other words, the first information is transmitted by the terminal device after successfully performing the RRC connection re-establishment. That is, the terminal device may transmit the first information, to the cell after the RRC connection is re-established.

In some embodiments, after the terminal device successfully connects to a reselected primary cell, the terminal device transmits the first information. In other words, the first information is transmitted after the terminal device successfully connects to the reselected primary cell. That is, the terminal device may transmit the first information to the reselected primary cell.

In some embodiments, the fast MCG recovery failure report includes but is not limited to at least one of:
location information of the terminal device, an identity of a failed primary cell, configured duration information of T316, a measurement result of a cell in an SCG, indication information used to indicate that the terminal device has performed a fast MCG recovery, or indication information used to indicate that the terminal device has transmitted an MCG failure indication.

In some embodiments, the fast MCG recovery failure report may also include at least one of: distance change information between the terminal device and the MN, or distance change information between the terminal device and the SN.

In some embodiments, the location information of the terminal device includes but is not limited to at least one of:

location information of the terminal device before an MCG failure occurs, or location information of the terminal device before the terminal device transmits an RRC re-establishment request (RRC Re-establishment Request).

In some implementations, the location information of the terminal device before the MCG failure occurs may be: location information of the terminal device recorded before the MCG failure occurs, or location information of the terminal device recorded for a period of time before the MCG failure occurs, or location information of the terminal device recorded for last n times before the MCG failure occurs, where n is a positive integer.

In some implementations, the location information of the terminal device before the terminal device transmits the RRC re-establishment request may be: location information of the terminal device recorded before the terminal device transmits the RRC re-establishment request, or location information of the terminal device recorded for a period of time before the terminal device transmits the RRC re-establishment request, or location information of the terminal device recorded for last N times before the terminal device transmits the RRC re-establishment request, where N is a positive integer.

In some embodiments, the measurement result of the cell in the SCG includes but is not limited to at least one of:

a measurement result of the cell in the SCG before an MCG failure, a measurement result of the cell in the SCG before the T316 expires, a measurement result of the cell in the SCG before the terminal device performs a cell reselection, or a measurement result of the cell in the SCG before the terminal device transmits an RRC re-establishment request.

In some embodiments, the cell in the SCG includes a primary secondary cell (PSCell) and/or a secondary cell (SCell).

In some embodiments, the measurement result includes but is not limited to at least one of:

reference signal received power (Reference Signal Received Power, RSRP), reference signal received quality (Reference Signal Received Quality, RSRQ), or signal to interference plus noise ratio (Signal to Interference plus Noise Ratio, SINR).

In the embodiments of the present disclosure, the network device may set a more appropriate T316 duration according to the actual feedback of the terminal device, and in a case where the connection between the terminal device and the SN is predicted to be bad, the RRC re-establishment process may be performed faster.

For example, the network finds that terminals at a certain location always experience the MCG failure and then experience the SCG failure, which proves that the terminals at the location are not appropriate for being configured with an overly long T316.

For another example, if the network finds that terminals holding measurement results within a fixed range always experience the MCG failure and then experience the SCG failure, it proves that this type of terminals is not appropriate for being configured with an overly long T316.

In some embodiments, the terminal device generates the fast MCG recovery failure report in a case where at least one of the following conditions is met:

a condition that the fast MCG recovery has been performed and the T316 has expired;
a condition that the fast MCG recovery has been performed and a cell reselection has been performed;
a condition that the fast MCG recovery has been performed and an RRC re-establishment request has been transmitted;
a condition that the MCG failure indication is transmitted to an MN, and the T316 has expired;
a condition that the MCG failure indication is transmitted to an MN and a cell reselection has been performed; or
a condition that the MCG failure indication is transmitted to an MN, and an RRC re-establishment request has been transmitted.

In some embodiments, the MCG failure indication is transmitted to the MN via the SCG.

In some embodiments, the terminal device transmits first indication information.

Herein, the first indication information is used to indicate that the terminal device has the fast MCG recovery failure report to be reported.

For example, the terminal device transmits the first indication information to the network device.

In some embodiments, after receiving the first indication information, the network device learns that the terminal device has the fast MCG recovery failure report to be reported, and further, may indicate or request the terminal device to report the fast MCG recovery failure report.

In some embodiments, the first indication information is carried via an RRC signaling. Herein, the RRC signaling is an RRC connection setup complete message (RRCConnectionSetupComplete), or the RRC signaling is an RRC connection re-establishment complete message (RRCConnectionRe-establishmentComplete).

In some embodiments, the terminal device receives first request information.

Herein, the first request information is used to request the terminal device to report the fast MCG recovery failure report.

In some embodiments, after receiving the first request information, the terminal device may report the fast MCG recovery failure report.

Therefore, in the embodiments of the present disclosure, the network device (such as the MN in which the primary cell corresponding to the fast MCG recovery failure is located) may optimize the fast MCG recovery based on the fast MCG recovery failure report, for example, optimize a relevant configuration of T316 (such as the duration or starting and stopping conditions of T316). Therefore, in a case where the link quality between the terminal device and the SN deteriorates, the RRC re-establishment process may be performed faster, thereby improving the mobility and robustness of the fast MCG recovery, and meanwhile, optimizing the communication system.

The method embodiments of the present disclosure are described in detail in combination with FIG. 4 above. Apparatus embodiments of the present disclosure will be described in detail in combination with FIG. 5 to FIG. 9 below. It should be understood that the apparatus embodiments and the method embodiments correspond to each other, and similar descriptions for the apparatus embodiments may refer to the method embodiments.

FIG. 5 shows a schematic block diagram of a terminal device 300 according to the embodiments of the present disclosure. As shown in FIG. 5, the terminal device 300 includes:

a processing unit 310, configured to generate first information, where the first information includes a fast master cell group (MCG) recovery failure report; and
a communication unit 320, configured to transmit the first information.

In some embodiments, the fast MCG recovery failure report includes at least one of:

location information of the terminal device, an identity of a failed primary cell, configured duration information of T316, a measurement result of a cell in a secondary cell group (SCG), indication information used to indicate that the terminal device has performed a fast MCG recovery, or indication information used to indicate that the terminal device has transmitted an MCG failure indication.

In some embodiments, the location information of the terminal device includes at least one of:

location information of the terminal device before an MCG failure occurs, or location information of the terminal device before the terminal device transmits a radio resource control (RRC) re-establishment request.

In some embodiments, the measurement result of the cell in the SCG includes at least one of:

a measurement result of the cell in the SCG before an MCG failure, a measurement result of the cell in the SCG before the T316 expires, a measurement result of the cell in the SCG before the terminal device performs a cell reselection, or a measurement result of the cell in the SCG before the terminal device transmits an RRC re-establishment request.

In some embodiments, the cell in the SCG includes a primary secondary cell and/or a secondary cell.

In some embodiments, the processing unit 310 is further configured to generate the fast MCG recovery failure report in a case where at least one of the following conditions is met:

a condition that the fast MCG recovery has been performed and the T316 has expired;
a condition that the fast MCG recovery has been performed and a cell reselection has been performed;
a condition that the fast MCG recovery has been performed and an RRC re-establishment request has been transmitted;
a condition that the MCG failure indication is transmitted to a master node (MN), and the T316 has expired;
a condition that the MCG failure indication is transmitted to an MN and a cell reselection has been performed; or
a condition that the MCG failure indication is transmitted to an MN, and an RRC re-establishment request has been transmitted.

In some embodiments, the MCG failure indication is transmitted to the MN via the SCG.

In some embodiments, the communication unit 320 is further configured to transmit first indication information.

Herein, the first indication information is used to indicate that the terminal device has the fast MCG recovery failure report to be reported.

In some embodiments, the first indication information is carried by an RRC signaling, where the RRC signaling is an RRC connection setup complete message, or the RRC signaling is an RRC connection re-establishment complete message.

In some embodiments, the communication unit 320 is further configured to receive first request information.

Herein, the first request information is used to request the terminal device to report the fast MCG recovery failure report.

In some embodiments, the communication unit 320 is configured to:

transmit the first information after the terminal device successfully performs an RRC connection re-establishment; or,
transmit the first information after the terminal device successfully connects to a reselected primary cell.

In some embodiments, the above communication unit may be a communication interface or a transceiver, or an input/output interface of a communication chip or a system on chip. The above processing unit may be one or more processors.

It should be understood that the terminal device 300 according to the embodiments of the present disclosure may correspond to the terminal device in the method embodiments of the present disclosure, and the above and other operations and/or functions of various units in the terminal device 300 are respectively for implementing the corresponding processes of the terminal device in the method 200 shown in FIG. 4, which will not be repeated here, for the sake of brevity.

FIG. 6 shows a schematic block diagram of a network device 400 according to the embodiments of the present disclosure. As shown in FIG. 6, the network device 400 includes:

a communication unit 410, configured to receive first information, where the first information includes a fast master cell group (MCG) recovery failure report.

In some embodiments, the fast MCG recovery failure report includes at least one of:

location information of a terminal device, an identity of a failed primary cell, configured duration information of T316, a measurement result of a cell in a secondary cell group (SCG), indication information used to indicate that a terminal device has performed a fast MCG recovery, or indication information used to indicate that a terminal device has transmitted an MCG failure indication.

In some embodiments, the location information of the terminal device includes at least one of:

location information of the terminal device before an MCG failure, or location information of the terminal device before the terminal device transmits a radio resource control (RRC) re-establishment request.

In some embodiments, the measurement result of the cell in the SCG includes at least one of:

a measurement result of the cell in the SCG before an MCG failure, a measurement result of the cell in the SCG before the T316 expires, a measurement result of the cell in the SCG before the terminal device performs a cell reselection, or a measurement result of the cell in the SCG before the terminal device transmits an RRC re-establishment request.

In some embodiments, the cell in the SCG includes a primary secondary cell and/or a secondary cell.

In some embodiments, the fast MCG recovery failure report is generated in a case where at least one of the following conditions is met:

a condition that the fast MCG recovery has been performed and the T316 has expired;
a condition that the fast MCG recovery has been performed and a cell reselection has been performed;
a condition that the fast MCG recovery has been performed and an RRC re-establishment request has been transmitted;
a condition that the MCG failure indication is transmitted to a master node (MN), and the T316 has expired;
a condition that the MCG failure indication is transmitted to an MN and a cell reselection has been performed; or a condition that the MCG failure indication is transmitted to an MN, and an RRC re-establishment request has been transmitted.

In some embodiments, the MCG failure indication is transmitted to the MN via the SCG.

In some embodiments, the communication unit 410 is further configured to receive first indication information.

Herein, the first indication information is used to indicate that a terminal device has the fast MCG recovery failure report to be reported.

In some embodiments, the first indication information is carried by an RRC signaling, where the RRC signaling is an RRC connection setup complete message, or the RRC signaling is an RRC connection re-establishment complete message.

In some embodiments, the communication unit 410 is further configured to transmit first request information.

Herein, the first request information is used to request a terminal device to report the fast MCG recovery failure report.

In some embodiments, the first information is transmitted after a terminal device successfully performs an RRC connection re-establishment; or,

the first information is transmitted after a terminal device successfully connects to a reselected primary cell.

In some embodiments, the communication unit 410 is further configured to transmit the fast MCG recovery failure report to an MN in which a failed primary cell is located.

Herein, the fast MCG recovery failure report is used to optimize a T316 configuration by the MN in which the failed primary cell is located.

In some embodiments, the above communication unit may be a communication interface or a transceiver, or an input/output interface of a communication chip or a system on chip. The above processing unit may be one or more processors.

It should be understood that the network device 400 according to the embodiments of the present disclosure may correspond to the network device in the method embodiments of the present disclosure, and the above and other operations and/or functions of various units in the network device 400 are respectively for implementing the corresponding processes of the network device in the method 200 shown in FIG. 4, which will not be repeated here, for the sake of brevity.

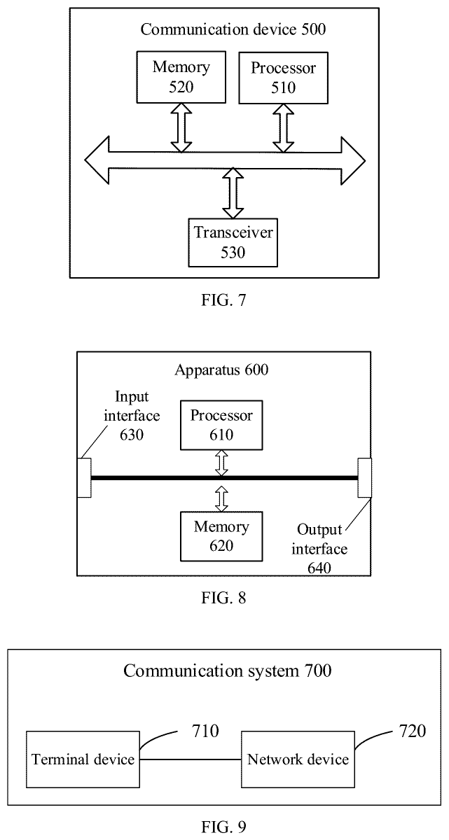

FIG. 7 is a schematic structural diagram of a communication device 500 provided in the embodiments of the present disclosure. The communication device 500 shown in FIG. 7 includes a processor 510, and the processor 510 may invoke a computer program from a memory and execute the computer program, to implement the method in the embodiments of the present disclosure.

In some embodiments, as shown in FIG. 7, the communication device 500 may further include a memory 520. Herein, the processor 510 may invoke a computer program from the memory 520 and execute the computer program, to implement the method in the embodiments of the present disclosure.

Herein, the memory 520 may be a separate device independent of the processor 510, or may be integrated into the processor 510.

In some embodiments, as shown in FIG. 7, the communication device 500 may also include a transceiver 530, and the processor 510 may control the transceiver 530 to communicate with other devices, and for example, to transmit information or data to other devices, or receive information or data transmitted by other devices.

Herein, the transceiver 530 may include a transmitter and a receiver. The transceiver 530 may further include antennas, and the number of antennas may be one or more.

In some embodiments, the processor 510 may implement the functions of the processing unit in the terminal device, or the processor 510 may implement the functions of the processing unit in the network device, which will not be repeated here for the sake of brevity.

In some embodiments, the transceiver 530 may implement the function of the communication unit in the terminal device, which will not be repeated here for the sake of brevity.

In some embodiments, the transceiver 530 may implement the function of the communication unit in the network device, which will not be repeated here for the sake of brevity.

In some embodiments, the communication device 500 may be the network device of the embodiments of the present disclosure, and the communication device 500 may implement the corresponding processes implemented by the network device in various methods of the embodiments of the present disclosure, which will not be repeated here for the sake of brevity.

In some embodiments, the communication device 500 may be the terminal device of the embodiments of the present disclosure, and the communication device 500 may implement the corresponding processes implemented by the terminal device in various methods of the embodiments of the present disclosure, which will not be repeated here for the sake of brevity.

FIG. 8 is a schematic structural diagram of an apparatus of the embodiments of the present disclosure. The apparatus 600 shown in FIG. 8 includes a processor 610, the processor 610 may invoke and execute a computer program from a memory to implement the method in the embodiments of the present disclosure.

In some embodiments, as shown in FIG. 8, the apparatus 600 may further include a memory 620. Herein, the processor 610 may invoke and execute a computer program from the memory 620 to implement the method in the embodiments of the present disclosure.

Herein, the memory 620 may be a separate device independent from the processor 610, or may also be integrated into the processor 610.

In some embodiments, the apparatus 600 may further include an input interface 630. Herein, the processor 610 may control the input interface 630 to communicate with other devices or chips, and for example, the input interface 630 may acquire information or data sent by other devices or chips. Optionally, the processor 610 may be located in a chip or out of the chip.

In some embodiments, the processor 610 may implement the functions of the processing unit in the terminal device, or the processor 610 may implement the functions of the processing unit in the network device, which will not be repeated here for the sake of brevity.

In some embodiments, the input interface 630 may implement the function of the communication unit in the terminal device, or the input interface 630 may implement the function of the communication unit in the network device.

In some embodiments, the apparatus 600 may further include an output interface 640. Herein, the processor 610 may control the output interface 640 to communicate with other devices or chips, and for example, the output interface 640 may output information or data to other devices or chips. Optionally, the processor 610 may be located in a chip or out of the chip.

In some embodiments, the output interface 640 may implement the function of the communication unit in the terminal device, or the output interface 640 may implement the function of the communication unit in the network device.

In some embodiments, the apparatus may be applied to the network device in the

embodiments of the present disclosure, and the apparatus may implement the corresponding procedure implemented by the network device in the various methods of the embodiments of the present disclosure, which will not be repeated here for the sake of brevity.

In some embodiments, the apparatus may be applied to the terminal device in the embodiments of the present disclosure, and the apparatus may implement the corresponding procedure implemented by the terminal device in the various methods of the embodiments of the present disclosure, which will not be repeated here for the sake of brevity.

In some embodiments, the apparatus mentioned in the embodiments of the present disclosure may also be a chip. For example, it may be a system on chip, a system chip, a chip system or a system-on-chip chip, etc.

FIG. 9 is a schematic block diagram of a communication system 700 provided in the embodiments of the present disclosure. As shown in FIG. 9, the communication system 700 includes a terminal device 710 and a network device 720.

Herein, the terminal device 710 may be configured to implement the corresponding functions implemented by the terminal device in the aforementioned methods, and the network device 720 may be configured to implement the corresponding functions implemented by the network device in the aforementioned methods, which will not be repeated here for the sake of brevity.

It should be understood that the processor in the embodiments of the present disclosure may be an integrated circuit chip and have a processing capability of signals. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present disclosure may be implemented or performed. A general-purpose processor may be a microprocessor, or the processor may also be any conventional processor, etc. The steps of the method disclosed in combination with the embodiments of the present disclosure may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the memory, and the processor reads the information in the memory and completes the steps of the above methods in combination with its hardware.

It may be understood that, the memory in the embodiments of the present disclosure may be a volatile memory or a non-volatile memory, or may include both volatile and non-volatile memories. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the system and the method described herein is intended to include, but not limited to, these and any other suitable types of memories.

It should be understood that the above memory is exemplary but not limiting illustration, e.g., the memory in embodiments of the present disclosure may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), etc. That is, the memory in the embodiments of the present disclosure is intended to include, but not limited to, these and any other suitable types of memories.

The embodiments of the present disclosure further provide a non-transitory computer-readable storage medium for storing a computer program.

In some embodiments, the non-transitory computer-readable storage medium may be applied to the network device in the embodiments of the present disclosure, and the computer program causes a computer to perform the corresponding procedure implemented by the network device in the various methods of the embodiments of the present disclosure, which will not be repeated here for the sake of brevity.

In some embodiments, the non-transitory computer-readable storage medium may be applied to the terminal device in the embodiments of the present disclosure, and the computer program causes a computer to perform the corresponding procedure implemented by the terminal device in various methods of the embodiments of the present disclosure, which will not be repeated here for the sake of brevity.

The embodiments of the present disclosure further provide a computer program product including a computer program instruction.

In some embodiments, the computer program product may be applied to the network device in the embodiments of the present disclosure, and the computer program instruction causes a computer to perform the corresponding procedure implemented by the network device in the various methods of the embodiments of the present disclosure, which will not be repeated here for the sake of brevity.

In some embodiments, the computer program product may be applied to the terminal device in the embodiments of the present disclosure, and the computer program instruction causes a computer to perform the corresponding procedure implemented by the terminal device in various methods of the embodiments of the present disclosure, which will not be repeated here for the sake of brevity.

The embodiments of the present disclosure further provide a computer program.

In some embodiments, the computer program may be applied to the network device in the embodiments of the present disclosure, the computer program when being executed on a computer, causes the computer to perform the corresponding procedure implemented by the network device in various methods of the embodiments of the present disclosure, which will not be repeated here for the sake of brevity.

In some embodiments, the computer program may be applied to the terminal device in the embodiments of the present disclosure, the computer program when being executed on a computer, causes the computer to perform the corresponding procedure implemented by the terminal device in various methods of the embodiments of the present disclosure, which will not be repeated here for the sake of brevity.

Those ordinary skilled in the art may realize that units and algorithm steps of the examples described in combination with the embodiments disclosed herein can be implemented in electronic hardware or in a combination of computer software and electronic hardware. Whether these functions are performed by way of hardware or software depends on an application and a design constraint of the technical solution. A skilled person may use different methods for each application, to implement the described functions, but such implementation should not be considered beyond the scope of the present disclosure.

It may be clearly understood by those skilled in the art that, for convenience and brevity of the description, the working procedures of the system, the apparatus and the unit described above may refer to the corresponding procedures in the above method embodiments, which will not be repeated here.

In the several embodiments provided by the disclosure, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present disclosure may be integrated into one processing unit, or the various units may exist physically separately, or two or more units may be integrated into one unit.

If the described functions are implemented in the form of a software functional unit and sold or used as an independent product, they may be stored in a non-transitory computer-readable storage medium. For this understanding, the technical solution of the present disclosure essentially, or a part of the technical solution that contributes to the prior art, or a part of the technical solution, may be embodied in the form of a software product, and the computer software product is stored in a storage medium, and includes a plurality of instructions for enabling a computer device (which may be a personal computer, a server, or a network device, etc.) to perform all or some of steps of the methods described in the various embodiments of the present disclosure. And, the storage medium mentioned above includes a USB flash drive (U disk), a mobile hard disk, a Read-Only Memory (ROM), a Random Access Memory (RAM), a diskette, or an optical disk, and various mediums that may store program codes.

The above content is only exemplary implementations of the present disclosure, but the protection scope of the present disclosure is not limited thereto, and any skilled familiar with this technical field may easily think of changes or substitutions within the technical scope disclosed in the present disclosure, which should be all covered within the protection scope of the present disclosure. Therefore, the protection scope of the present disclosure should be subject to the protection scope of the claims.

What is claimed is:

1. A wireless communication method, applied to a terminal device, wherein the method comprises:
generating first information, wherein the first information comprises a fast master cell group (MCG) recovery failure report; and
transmitting the first information.

2. The method according to claim 1, wherein
the fast MCG recovery failure report comprises at least one of:
location information of the terminal device, an identity of a failed primary cell, configured duration information of T316, a measurement result of a cell in a secondary cell group (SCG), indication information used to indicate that the terminal device has performed a fast MCG recovery, or indication information used to indicate that the terminal device has transmitted an MCG failure indication.

3. The method according to claim 2, wherein
the location information of the terminal device comprises at least one of:
location information of the terminal device before an MCG failure occurs, or location information of the terminal device before the terminal device transmits a radio resource control (RRC) re-establishment request;
and/or
the measurement result of the cell in the SCG comprises at least one of:
a measurement result of the cell in the SCG before an MCG failure, a measurement result of the cell in the SCG before the T316 expires, a measurement result of the cell in the SCG before the terminal device performs a cell reselection, or a measurement result of the cell in the SCG before the terminal device transmits an RRC re-establishment request;
wherein the cell in the SCG comprises a primary secondary cell and/or a secondary cell.

4. The method according to claim 2, wherein the method further comprises:
generating the fast MCG recovery failure report in a case where at least one of the following conditions is met:
a condition that the fast MCG recovery has been performed and the T316 has expired;
a condition that the fast MCG recovery has been performed and a cell reselection has been performed;
a condition that the fast MCG recovery has been performed and an RRC re-establishment request has been transmitted;
a condition that the MCG failure indication is transmitted to a master node (MN), and the T316 has expired;
a condition that the MCG failure indication is transmitted to an MN and a cell reselection has been performed; or
a condition that the MCG failure indication is transmitted to an MN, and an RRC re-establishment request has been transmitted.

5. The method according to claim 4, wherein the MCG failure indication is transmitted to the MN via the SCG.

6. The method according to claim 1, wherein the method further comprises:
transmitting first indication information;
wherein the first indication information is used to indicate that the terminal device has the fast MCG recovery failure report to be reported;
and/or
the method further comprises:
receiving first request information;
wherein the first request information is used to request the terminal device to report the fast MCG recovery failure report.

7. The method according to claim 1, wherein
the transmitting the first information, comprises:
transmitting the first information after the terminal device successfully performs an RRC connection re-establishment; or,
transmitting the first information after the terminal device successfully connects to a reselected primary cell.

8. A terminal device, comprising: a processor and a memory, wherein the memory is configured to store a computer program, and the processor is configured to invoke and execute the computer program stored in the memory, to enable the terminal device to perform:
generating first information, wherein the first information comprises a fast master cell group (MCG) recovery failure report; and
transmitting the first information.

9. The terminal device according to claim 8, wherein
the fast MCG recovery failure report comprises at least one of:
location information of the terminal device, an identity of a failed primary cell, configured duration information of T316, a measurement result of a cell in a secondary cell group (SCG), indication information used to indicate that the terminal device has performed a fast MCG recovery, or indication information used to indicate that the terminal device has transmitted an MCG failure indication.

10. The terminal device according to claim 9, wherein
the location information of the terminal device comprises at least one of:
location information of the terminal device before an MCG failure occurs, or location information of the terminal device before the terminal device transmits a radio resource control (RRC) re-establishment request;
and/or
the measurement result of the cell in the SCG comprises at least one of:
a measurement result of the cell in the SCG before an MCG failure, a measurement result of the cell in the SCG before the T316 expires, a measurement result of the cell in the SCG before the terminal device performs a cell reselection, or a measurement result of the cell in the SCG before the terminal device transmits an RRC re-establishment request;
wherein the cell in the SCG comprises a primary secondary cell and/or a secondary cell.

11. The terminal device according to claim 9, wherein the terminal device further performs:
generating the fast MCG recovery failure report in a case where at least one of the following conditions is met:
a condition that the fast MCG recovery has been performed and the T316 has expired;
a condition that the fast MCG recovery has been performed and a cell reselection has been performed;
a condition that the fast MCG recovery has been performed and an RRC re-establishment request has been transmitted;
a condition that the MCG failure indication is transmitted to a master node (MN), and the T316 has expired;
a condition that the MCG failure indication is transmitted to an MN and a cell reselection has been performed; or
a condition that the MCG failure indication is transmitted to an MN, and an RRC re-establishment request has been transmitted.

12. The terminal device according to claim 8, wherein the terminal device further performs:
transmitting first indication information;
wherein the first indication information is used to indicate that the terminal device has the fast MCG recovery failure report to be reported;
and/or
the terminal device further performs:
receiving first request information;
wherein the first request information is used to request the terminal device to report the fast MCG recovery failure report.

13. The terminal device according to claim 8, wherein the terminal device performs:
transmitting the first information after the terminal device successfully performs an RRC connection re-establishment; or,
transmitting the first information after the terminal device successfully connects to a reselected primary cell.

14. A network device, comprising: a processor and a memory, wherein the memory is configured to store a computer program, and the processor is configured to invoke and execute the computer program stored in the memory, to enable the network device to perform:
receiving first information, wherein the first information comprises a fast master cell group (MCG) recovery failure report.

15. The network device according to claim 14, wherein
the fast MCG recovery failure report comprises at least one of:
location information of a terminal device, an identity of a failed primary cell, configured duration information of T316, a measurement result of a cell in a secondary cell group (SCG), indication information used to indicate that a terminal device has performed a fast MCG recovery, or indication information used to indicate that a terminal device has transmitted an MCG failure indication.

16. The network device according to claim 15, wherein
the location information of the terminal device comprises at least one of:
location information of the terminal device before an MCG failure, or location information of the terminal device before the terminal device transmits a radio resource control (RRC) re-establishment request;
and/or
the measurement result of the cell in the SCG comprises at least one of:
a measurement result of the cell in the SCG before an MCG failure, a measurement result of the cell in the SCG before the T316 expires, a measurement result of the cell in the SCG before the terminal device performs a cell reselection, or a measurement result of the cell in the SCG before the terminal device transmits an RRC re-establishment request;
wherein the cell in the SCG comprises a primary secondary cell and/or a secondary cell.

17. The network device according to claim 15, wherein
the fast MCG recovery failure report is generated in a case where at least one of the following conditions is met:
a condition that the fast MCG recovery has been performed and the T316 has expired;
a condition that the fast MCG recovery has been performed and a cell reselection has been performed;
a condition that the fast MCG recovery has been performed and an RRC re-establishment request has been transmitted;
a condition that the MCG failure indication is transmitted to a master node (MN), and the T316 has expired;
a condition that the MCG failure indication is transmitted to an MN and a cell reselection has been performed; or
a condition that the MCG failure indication is transmitted to an MN, and an RRC re-establishment request has been transmitted.

18. The network device according to claim 14, wherein the network device further performs:
receiving first indication information;
wherein the first indication information is used to indicate that a terminal device has the fast MCG recovery failure report to be reported;
and/or
the network device further performs:
transmitting first request information;
wherein the first request information is used to request a terminal device to report the fast MCG recovery failure report.

19. The network device according to claim 14, wherein
the first information is transmitted after a terminal device successfully performs an RRC connection re-establishment; or,
the first information is transmitted after a terminal device successfully connects to a reselected primary cell.

20. The network device according to claim 14, wherein the network device further performs:
transmitting the fast MCG recovery failure report to an MN in which a failed primary cell is located;
wherein the fast MCG recovery failure report is used to optimize a T316 configuration by the MN in which the failed primary cell is located.
